(19) United States
(12) Patent Application Publication
(10) Pub. No.: US 2016/0165705 A1
(43) Pub. Date: Jun. 9, 2016

(54) T5 LAMP END OF LIFE PROTECTION CIRCUIT

(71) Applicants: Bo ZHANG, Shanghai (CN); Zhu MAO, Shanghai (CN); GENERAL ELECTRIC COMPANY, Schenectady, NY (US)

(72) Inventors: Bo ZHANG, Shanghai (CN); Zhu MAO, Shanghai (CN)

(21) Appl. No.: 14/907,644

(22) PCT Filed: Jul. 30, 2013
(86) PCT No.: PCT/CN2013/080380

§ 371 Date: Jan. 26, 2016

(51) Int. Cl. H05B 41/298

(52) U.S. Cl. CPC H05B 41/2985

(57) ABSTRACT

Provided are an end-of-life protection circuit for a non-isolated electronic ballast and a method for protecting same. The non-isolated electronic ballast includes a driver circuit (104), a sampling circuit (108), and a control circuit (102). The driver circuit (104) connects to an output circuit (106) for controlling operation of a load. The sampling circuit (108) samples direct current (DC) voltage values of a capacitor of a lamp coupled to the ballast to detect occurrence of an asymmetric event. The control circuit (102) receives a voltage value in response to detecting the asymmetric event and outputs to the driver circuit (104) a control signal to control operation of the driver circuit (104) to prevent end-of-life damage. Provided also are an end-of-life protection circuit for an isolated electronic ballast and a method for protecting same.

### I. FIELD OF THE INVENTION

The present invention relates generally to an end of life protection circuit for detecting events in a lamp ballast. More particularly, the present invention relates a lamp protection circuit for detecting asymmetry for smaller diameter lamps such as T5 or small T5 diameter fluorescent lamps.

### II. BACKGROUND OF THE INVENTION

When using fluorescent lamps, all components of operation must be taken into account with reference to the end of life events. In addition to the light source, this includes the luminaires and the ballast. The characteristics of the light components for operation are regulated according to relevant international standards and specifications. For example, two key standards that impact the end of life conditions for electronic ballasts are governed by International Standard IEC 61347-2-3 (Particular Requirements for A.C. Supplied Electronic Ballasts for Fluorescent Lamps) and Section 22 of Underwriters Laboratories Standard UL 935 (UL Standard for Safety for Fluorescent Lamp Ballasts). These standards ensure that the lamps and electronic ballasts are functioning together in a proper way.

The use of electronic ballasts is regulated by the International Standard IEC 61347-2-3, which stipulates that electronic ballasts shall behave at the end of the lamp's life in such a way that no adverse overheating of the lamp and the lamp cap occurs. Overheating is a particular problem with small diameter lamp tubes and compact fluorescent lamps especially toward the end of the lamp's life. When using electronic ballasts in connection with fluorescent lamps, the standard also calls for a permanently effective end of life safety shutdown.

The IEC 61347-2-3 further stipulates that electronic ballasts should work properly and securely even when the fluorescent tubes are functioning under end of life conditions. Electronic ballasts used in fluorescent lighting systems may experience high failure rates due to several end of life issues. One end of life condition typically results from exhausting the electronic powder inside the tube. During the start-up phase, if the tube cannot be successfully ignited, high current will flow through the resonant circuit and there will be high voltage at both terminals of the tube, especially in thin tubes such as T5 or T4 where the voltage is even higher. This high current or high voltage will not only cause damage to the tube's base, it may also pose a hazard to the operator who is replacing the tube.

Another end of life issue refers to the rectifying effect of fluorescent tubes. A rectifying effect is caused by the frequent inconsistency (“asymmetry”) of the arc current of the lamp in consecutive half-cycles, which is typically a result of damage to the cathode filament or the inability to emit electrons by the emissive material inside the tube. Asymmetry occurs when the lamp current for column discharge of one polarity is different from the lamp current for the column discharge of the other polarity.

A brief explanation of asymmetry as it relates to rectifying is provided in U.S. Pat. No. 5,808,422, which is incorporated by reference. During lamp operation, ballasts for gas discharge lamps commonly provide an AC voltage across the lamp so that the lamp current is alternating and a column discharge is maintained between the lamp electrodes during both the positive and negative half-cycles of the AC output voltage. During the positive half-cycle, one electrode is the cathode and the other is the anode. The electrodes assume the opposite function for the negative half-cycle. When an electrode is the cathode, it emits electrons to ignite and maintain the column discharge during the respective half-cycle. The electrodes typically include an electron emissive material which provides an ample supply of electrons when the electrode is the cathode. During lamp life, the discharge electrodes age and lose emitter material through known processes, typically at a slightly different rate.

Consequently, it is common for the lamp to reach an end of life condition in which one of the electrodes, when the cathode, is unable to supply sufficient electrons to ignite and maintain the column discharge, which results in a column discharge being maintained during only the negative or positive half cycles of the AC output voltage. In this half-wave discharge condition, the lamp essentially acts as a rectifier.

This rectifying effect will concentrate the high output energy of the electronic ballast on the small cathode of the lamp, which will in turn produce a very high temperature. The increasing temperature of the lamp holder can lead to thermal deformation of the lamp causing the glass to melt. This may lead to a tube falling off the fixture or, even more seriously, can result in a thermal event. Therefore, the ballast must be protected against an abnormal rectifying effect.

Regardless of these end of life issues, the efficiency, power factor and luminous efficacy of electronic ballasts are typically still better than those of electromagnetic ballasts. Because of these advantages, fluorescent lamps using low-power-consumption electronic ballasts are being promoted as green energy-saving lighting products. Replacing traditional electromagnetic ballasts and T8 tubes with electronic ballasts and T5 tubes offers significant economic and social benefits.

However when replacing the traditional ballast, selecting the correct over current protection device can pose challenges. For instance, while the impact of the surge must be taken into account, if the current value of the fuse is set too high it cannot provide effective protection. Also, when trying to provide for overcurrent protection against an end of life state, if the current value of the fuse is set too low then faults can occur.

In addition, the ballast needs to be able to support multiple wattages and lamps lengths that operate and provide end of life protection at different voltages. The ballast needs to provide lamp voltage compatibility between different lamps having different voltages and simultaneously provide protections against end of life events. For example, T5 lamps may be compatible with 2×14 W, 2×28 W and 1×35 W. However, because there is such a big difference between the lamp voltage for the 14 W and 35, it is difficult to use normal protection device to protect the lamp when end of life events occur.

The IEC 61347-2-3 standard specifies three test to stimulate the effect of the lamp's end of life: the asymmetric pulse test; asymmetric power dissipation test and the open filament test. Any one of these three tests can be used to prove the eligibility of the electronic ballast. Therefore, there is a need for an over protection circuit that also meets this requirement.

As noted above, with the occurrence of an end of life event, the high current or high voltage will not only cause damage to the tube's base, it may also pose a hazard to the user who is replacing the tube. If the user touches the electrodes of the lamp, current may flow through the human body, thus possibly causing physical injury. Thus, it has long been known to apply a ground fault interrupt (GFI) circuit to the ballast for fluorescent lamps.

A conventional GFI circuit uses a sensor to measure unbalanced current between input live and neutral. The ballast can be either a non-isolated ballast or an isolated ballast. Most of the ballast are non-isolated ballast. Section 22 of Underwriters Laboratories Standard UL 935 provides guidance regarding reducing the risk of shock during replacement of such lamp. Section 22 of Underwriters Laboratories Standard UL 935 requires that non-isolated ballasts include some sort of through-lamp ground fault current limiting circuit in order to reduce the risk of electric shock for users of such ballasts.

Ground faults occur when a grounded person comes into contact with the pins at one end of a linear fluorescent lamp when the other end of the lamp is inserted in a lamp socket that is wired to an energized ballast. When a ground fault occurs, current flows from the ballast, through the fluorescent lamp and the grounded person, to ground. If the ballast does not include some type of current limiting circuit, the ballast may supply enough current to deliver a harmful shock to the grounded person. As a result of this requirement, through-lamp ground fault current limiting circuits for electronic ballasts are well known in the art.

In an isolated ballast, line input is isolated from an output high voltage terminal. However, when a person replaces electro-luminescent (EL) lamp, if the lighting fixture of the EL lamp is floating, there is still a leakage current coupled to the lighting fixture which can flow to the human body and back to ballast secondary output. Thus, even with an isolated ballast, there is still a risk of getting shocked when replacing such an EL lamp.

Prior attempts at lamp ballasts with shutdown circuits have resulted in implementations with various drawbacks. These prior art circuits require a large number of components count and their designs are complex. Furthermore, most prior art shutdown and lamp protection circuits are directed toward non-isolated ballast designs.

Therefore, there remains a need for a simple circuit to work with electronic ballasts to protect small diameter gas discharge lamps and compact fluorescent lamps from overheating and cracking.

There also remains a need to provide a lamp protection circuit for detecting asymmetry for smaller diameter lamps such as compact fluorescent lamps including both isolated and non-isolated ballast circuits. The protection circuit protects against several lamp failure modes that can cause filament overheating and cracking of the lamp.

### III. SUMMARY OF EMBODIMENTS OF THE INVENTION

In certain embodiments, an end-of-life protection circuit for a non-isolated electronic ballast is provided with an output circuit and a driver circuit. The driver circuit connects to the output circuit for controlling operation of a load. A sampling circuit samples direct current (DC) voltage values of a capacitor of a lamp coupled to the ballast to detect the occurrence of an asymmetric event. A control circuit receives a voltage value in response to the detection of the asymmetric event from the sampling circuit and outputs to the driver circuit a control signal to control the operation of the driver to prevent end of life damage.

In certain embodiments, a method for end-of-life protection for a non-isolated electronic ballast is provided, which includes providing an output circuit; providing a driver circuit connected to the output circuit for controlling operation of a load; sampling direct current (DC) voltage values of a capacitor of lamp to detect the occurrence of an asymmetric event; receiving, as input to a control circuit, a voltage value in response to the detection of the asymmetric event from the sampling circuit; and outputting, from the control circuit, to a driver circuit a control signal to control the operation of the driver to prevent end of life damage.

In other embodiments, an end-of-life protection circuit for an isolated electronic ballast is provided which includes an output circuit and a driver circuit. The driver circuit connects to the output circuit for controlling operation of a load. A detect and control circuit monitors direct current (DC) voltage values of a capacitor of lamp to detect the occurrence of an asymmetric event and outputs to the driver circuit a control signal to control the operation of the driver to prevent end of life damage.

In still other embodiments, a method for end-of-life protection for an isolated electronic ballast is provided, which includes providing an output circuit; providing a driver circuit connected to the output circuit for controlling operation of a load; and monitoring direct current (DC) voltage values of a capacitor of lamp to detect the occurrence of an asymmetric event and outputting to the driver circuit a control signal to control the operation of the driver to prevent end of life damage.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

FIG. 1 is a schematic and block diagram of an example of a non-isolated ballast circuit having an end-of-life circuit in accordance with the present invention;

FIG. 2 is a schematic and block diagram of an example of an isolated ballast circuit having an end-of-life circuit in accordance with the present invention;

FIG. 3 is a flowchart of an exemplary method of practicing the present invention in accordance with the present invention; and

FIG. 4 is a flowchart of another exemplary method of practicing the present invention in accordance with the present invention.

The present invention may take form in various components and arrangements of components, and in various process operations and arrangements of process operations. The present invention is illustrated in the accompanying drawings, throughout which, like reference numerals may indicate corresponding or similar parts in the various figures. The drawings are only for purposes of illustrating preferred embodiments and are not to be construed as limiting the invention. Given the following enabling description of the drawings, the novel aspects of the present invention should become evident to a person of ordinary skill in the art.

### V. DETAILED DESCRIPTION OF VARIOUS EMBODIMENTS

The following detailed description is merely exemplary in nature and is not intended to limit the applications and uses disclosed herein. Further, there is no intention to be bound by any theory presented in the preceding background or summary or the following detailed description. While embodiments of the present technology are described herein primarily in connection with T5 lamps, the concepts are also applicable to other types of lamp sizes (e.g., T8, T4, T1, T2, T3, or any other suitable lamp size).

In various embodiments, the present invention provides a device and method for a simple circuit that works with electronic ballasts to protect small diameter gas discharge lamps and compact fluorescent lamps from overheating and cracking.

In various embodiments, the present invention provides a lamp protection circuit for detecting asymmetry for smaller diameter lamps such as compact fluorescent lamps including both isolated and non-isolated ballast circuits. The protection circuit protects against several lamp failure modes that can cause filament overheating and cracking of the lamp.

In various embodiments, the present invention provides a ballast capable of supporting multiple wattages and lamps lengths that operate and provide end of life protection at different voltages. The ballast provides lamp voltage compatibility between different lamps having different voltages and simultaneously provide protections against end of life events.

Various embodiments provide a device and method that meet the requirements of the IEC 61347-2-3 standard, which specifies that three test to stimulate the effect of the lamp's end of life: the asymmetric pulse test; asymmetric power dissipation test and the open filament test. Any one of these three tests can be used to prove the eligibility of the electronic ballast. Various embodiments provide a device and method for an over protection circuit that also meets this requirement.

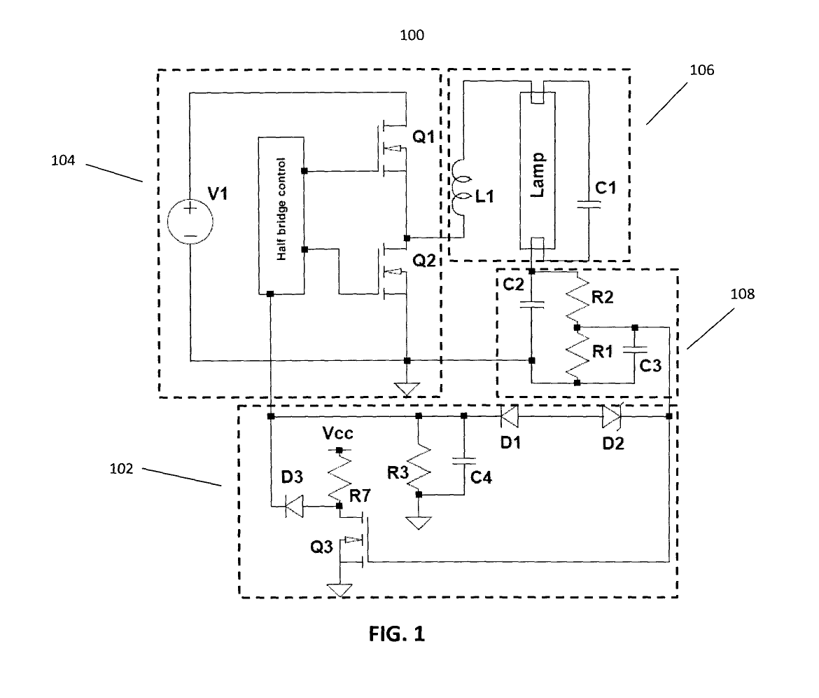

With reference to FIG. 1, a schematic diagram of an exemplary detection circuit 100 is illustrated. The detection circuit 100 can be utilized in a non-isolated electronic output ballast. The detection circuit 100 detects a DC voltage to determine whether an end of life event is occurring. In accordance with various features of the subject innovation, the electronic ballast may be utilized for a T5 discharge lamp, as well as other lamp sizes (e.g., T8, T4, T1, T2, T3, or any other suitable lamp size).

According to related aspects, the ballast circuit may be employed to provide an EOL detection for a lamp T5 (or other size lamp) ballast. It will be appreciated that although the T5 lamp is described in connection with most aspects disclosed herein, any suitable lamp size may be employed in conjunction with the described innovation, and any and all such lamp sizes are intended to fall within the scope and spirit of the described features.

An exemplary embodiment of an end of life detection circuit 100 for a non-isolated ballast is illustrated in FIG. 1. The detection circuit 100 detects asymmetry in the ballast to protect against end of life events. In the present examples, detection circuit 100 for the non-isolated ballast includes an end of life control circuit 102 that controls a half bridge driver circuit 104, the output of which is applied to the output and load circuit 106. The half bridge driver circuit 104 is composed of the DC voltage, the half bridge control, driver MOSFET Q1 and Q2. The DC voltage supplies the power for the half bridge circuit. The half bridge control may be either an IC controller or self-oscillation. The half bridge driver circuit sets a frequency for output, as well as provides default protection for end of life situations.

The half bridge powers the MOSFET Q1 and Q2. In various embodiments, a power module having power devices can be used in high voltage and high current applications. The power module can include a half-bridge power where the power devices are high side and low side devices that include, for example, a power metal-oxide-semiconductor field-effect transistor (MOSFET Q1, MOSFET Q2) as power switches.

The half bridge configuration under the half bridge controller or driver, circuit control provides high frequency substantially square wave output voltage to the output circuit 106. The output and load circuit 106 is composed of limit inductor L1, oscillation capacitor C1, and a lamp load. The output and load circuit 106 converts the substantially square wave of the half bridge into a sinusoidal lamp current.

The end of life signal sampling circuit 108 is composed of half bridge block capacitor C2, resistors R1 and R2, and end of life sensor capacitor C3. The sampling circuit 108 illustrated in FIG. 1 indicates a circuit employable for sensing and determining the threshold voltage across the lamp. A voltage sampling circuit monitors the output voltage by monitoring a voltage on the sampling capacitor. The waveform may be further processed with an end of life signal sampling circuit 108. In various embodiments, the end of life signal sampling circuit 108 may include a peak sample and hold circuit.

The detection circuit 100 includes a sensing circuit which activates the control circuit 102. The end of life sensor capacitor C3 of the sensing circuit senses a DC current path on the cathode or voltage across the lamp. The end of life control circuit 102 is composed of zener D2, diode D1, D3 filter cap C4 and discharge resistor R3, limit resistor R7, as well as MOSFET Q3.

FIG. 1 shows an example of a protection scheme utilizing an end of life detection device for a non-isolated output ballast, such as for example, in a T5 electronic ballast. During normal operation, the block capacitor C2 will be a DC voltage. The DC voltage will flow through resistors R1, R2 to end of life sensor capacitor C3. The end of life capacitor C3 will still be a DC voltage.

The DC voltage will be clamped by zener diode cathode D2 such that the zener diode cathode D2 will be a zero voltage. In the meantime, because the end of life sensor capacitor C3 is a DC voltage, the MOSFET Q3 will be turned ON and the zener diode cathode D2 will be zero voltage. No voltage will trigger the half bridge controller, so the ballast will operate in a normal state. During normal operation, the voltage is very low and does not affect the normal operating state.

When the lamp's positive current is high and an end of life state approaches, the lamp current will become asymmetric such that the DC component of the lamp voltage will no longer be small and will cause a voltage change in the half bridge block capacitor C2. When the lamp's positive current is high, the half bridge block capacitor C2 will be a very high DC voltage.

The high voltage will flow through resistors R1, R2 to end of life sensor capacitor C3. The end of life sensor capacitor C3 will still have a very high DC voltage. The high DC voltage will flow through zener diode cathode D2 and diode D1. The filter capacitor C4 and the discharge resistor R3 will be a DC voltage.

The voltage will trigger the half bridge controller to change the half bridge control, shut down the half bridge or instruct the half bridge to output a high frequency to provide the required ballast protection by preventing damage to the ballast components while the lamp is operating in unbalanced asymmetric state. Namely, if an end of life abnormal state occurs, the current flowing through the circuit will increase, for example, 5 to 6 times the normal operating current. As a result, this will cause the DC voltage to change.

When the lamp's negative current is high and an end of life state approaches, the lamp current will become asymmetric such that a voltage change in the half bridge block capacitor C2 will occur. When the lamp's negative current is high, the half bridge block capacitor C2 will be have a very negative voltage. The negative voltage flow through resistors R1, R2 to end of life sensor capacitor C3. The end of life sensor capacitor C3 will be still a very negative voltage.

The negative voltage will flow to MOSFET Q3 gate. The MOSFET Q3 will be turned OFF. The filter capacitor C4 and discharge resistor R3 will be a DC voltage. The voltage will trigger the half bridge controller to change half bridge control, shut down the half bridge or instruct the half bridge to output a high frequency to provide the required ballast protection by preventing damage to the ballast components while the lamp is operating in unbalanced asymmetric state.

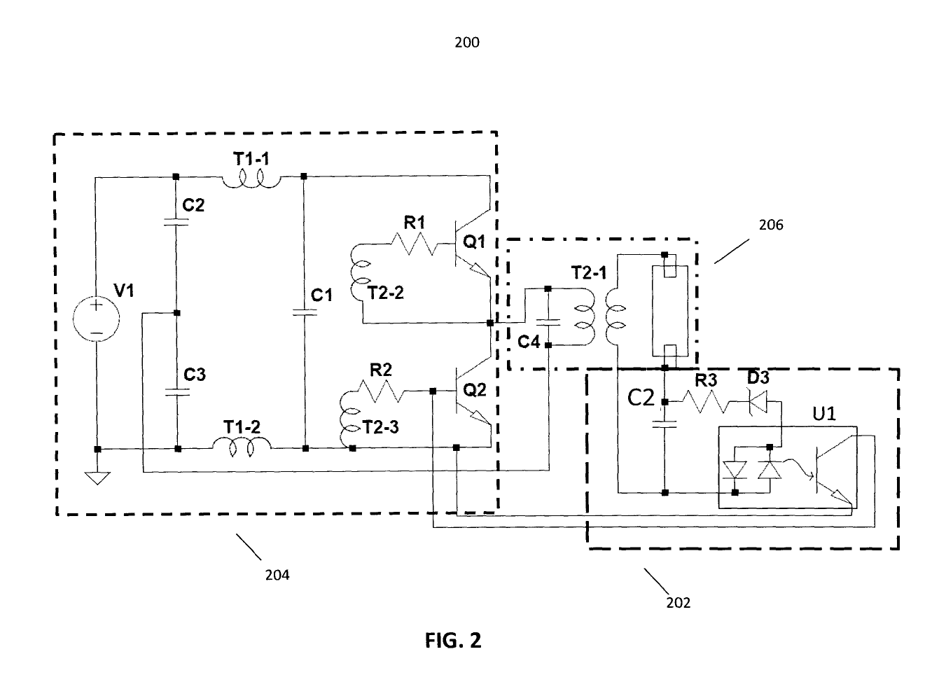

An exemplary embodiment of an end of life detection circuit 200 for an isolated ballast is illustrated in FIG. 2. The detection circuit 200 detects asymmetry in the ballast to protect against end of life events. In the present examples, detection circuit 200 for the isolated ballast includes an end of life control circuit 202 that controls a half bridge driver circuit 204, the output of which is applied to the output and load circuit 206. The half bridge driver circuit 204 is composed of the DC voltage, electrolytic capacitors C2, C3, limit transformer T1 (T1-1, T1-2), oscillation capacitor C1, as well as half-bridge power bipolar junction transistor (BJT) Q1, Q2, transformers T2-2, T2-3, and resistors R1, R2.

The DC voltage supplies the power for the half bridge circuit. The half bridge control may be either an IC controller or self-oscillation. The half bridge driver circuit sets a frequency for output, as well as provides default protection for end of life situations. In various embodiments, a power module having power devices can be used in high voltage and high current applications. The power module can include, in this example, a bipolar junction transistor (BJT). The bipolar junction transistor is a switching device utilized in many high power applications because of its ability to handle relatively large current densities and support relatively high blocking voltages.

BJTs are current controlled devices in that a BJT is turned “on” (i.e., it is biased so that current flows from the emitter to the collector) by flowing a current through the base of the transistor. By flowing a small current through the base of a BJT, a proportionally larger current passes from the emitter to the collector. These drive circuits are used to selectively provide a current to the base of the BJT that switches the transistor between its “on” and “off” states.

The output and load circuit 206 is composed of oscillation capacitor C4, output transformer T2-1 L1, and the lamp load.

The end of life detect and control circuit is composed of half bridge block capacitor C2, resistors R3, zener diode D3, and photocoupler U1.

FIG. 2 shows an example of a protection scheme utilizing an end of life detection device for an isolated output ballast. During normal operation, the block capacitor C2 will be a DC voltage. The DC voltage will be clamped by zener diode cathode D2 such that the photocoupler U1 will not operate and the ballast works according to normal operations.

When the lamp's positive current is high and an end of life state approaches, the lamp current will become asymmetric causing a voltage change in the half bridge block capacitor C2. When the lamp's positive current is high, the half bridge block capacitor C2 will be at a very high DC voltage. The high voltage will flow through zener D3. The photocoupler U1 will operate such that the photocoupler transistor U1 turns ON. The half-bridge power BJT driver will shut down so that the half-bridge stops operating. to provide the required ballast protection by preventing damage to the ballast components while the lamp is operating in unbalanced asymmetric state.

When the lamp's negative current is high and an end of life state approaches, the lamp current will become asymmetric such that a voltage change in the half bridge block capacitor C2 will occur. When the lamp's negative current is high, the half bridge block capacitor C2 will be at a very negative voltage. The negative voltage will flow through zener D3. The photocoupler U1 will operate such that the photocoupler transistor U1 turns ON. The half-bridge power BJT driver will shut down so that the half-bridge stops operating. to provide the required ballast protection by preventing damage to the ballast components while the lamp is operating in unbalanced asymmetric state.

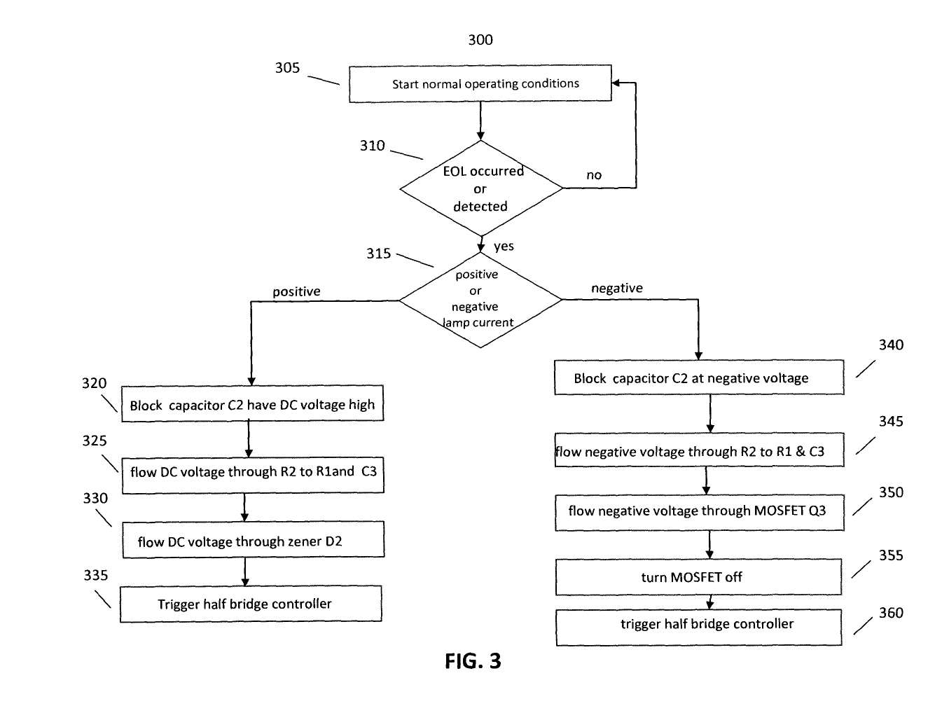

FIG. 3 is a flowchart of an exemplary method 300 of practicing a first embodiment of the present invention. FIG. 3 shows a flow diagram 300 illustrating one embodiment of an end of life protection device for a non-isolated output ballast in accordance with the present invention. The methodology 300 facilitates mitigating potentially dangerous lamp conditions, such as overheating, melting of the lamp and/or lamp sockets by effectively triggering the half-bridge controller to change the control parameters or to shut down the half-bridge driver circuit upon a determination that the lamp is at the end of its life.

In step 305, a lamp, such as a T5 lamp or the like, may power on and begin operating in a normal operating state. In step 310, a determination may be made whether an end of life event has occurred or has been detected. If no end of life event, the method may revert to 305 for continued operation of the lamp. In this sense, the loop between 305 and 310 may represent a continuous monitoring-and-feedback loop that facilitates monitoring the lamp for an EOL event without disturbing operation of the lamp.

If an EOL is detected at step 310, then at step 315, a determination may be made regarding whether lamp's current is positive or negative. If the lamp's current is positive, then at step 320, the half bridge block capacitor C2 will be set to a very high DC voltage. In step 325, the high voltage will flow through resistors R1, R2 to end of life sensor capacitor C3.

In step 330, the high DC voltage will flow through zener diode cathode D2 and diode D1. In step 335, the voltage will trigger the half bridge controller to change the half bridge control, shut down the half bridge or instruct the half bridge to output a high frequency, thereby reducing the possibility of a potentially dangerous occurrence of the lamp overheating.

If the lamp's negative current is high at step 315, then at step 340, the half bridge block capacitor C2 will be at a very negative voltage. In step 345, the negative voltage flow through resistors R1, R2 to end of life sensor capacitor C3. In step 350, the negative voltage will flow to MOSFET Q3 gate. In step 355, the MOSFET Q3 will be turned OFF.

The filter capacitor C4 and discharge resistor R3 will be a DC voltage. In step 460, the voltage will trigger the half bridge controller to change half bridge control, shut down the half bridge or instruct the half bridge to output a high frequency to provide the required ballast protection by preventing damage to the ballast components while the lamp is operating in unbalanced asymmetric state.

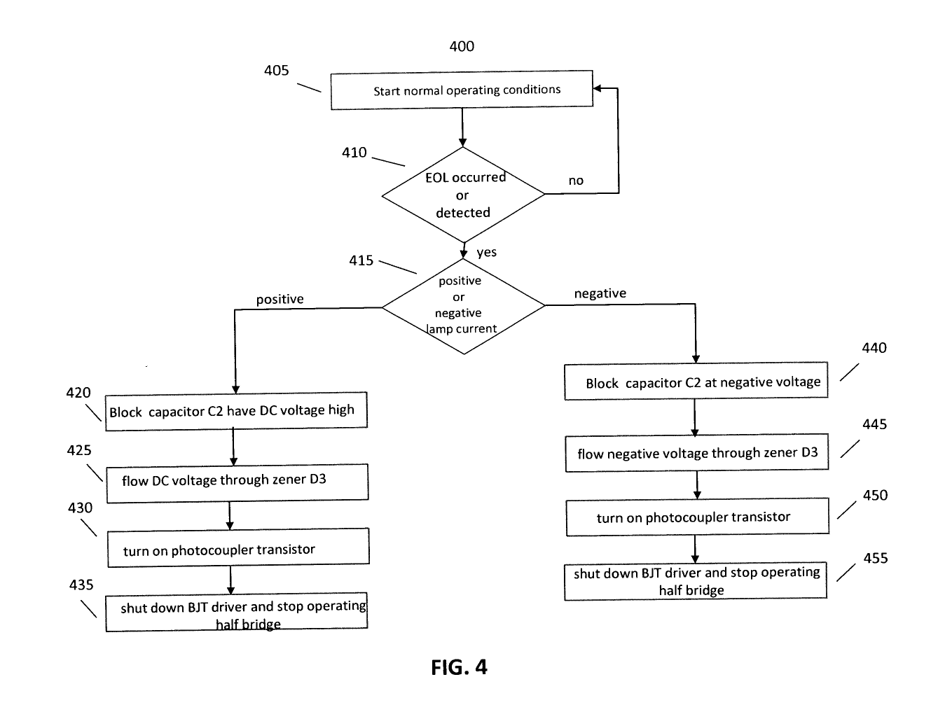

FIG. 4 is a flowchart of an exemplary method 400 of practicing a second embodiment of the present invention. FIG. 4 shows a flow diagram 400 illustrating one embodiment of an end of life protection device for an isolated output ballast in accordance with the present invention. The methodology 400 facilitates mitigating potentially dangerous lamp conditions, such as overheating, melting of the lamp and/or lamp sockets by effectively triggering the half-bridge controller to shut down the half-bridge driver circuit upon a determination that the lamp is at the end of its life.

In step 405, a lamp, such as a T5 lamp or the like, may power on and begin operating in a normal operating state. In step 410, a determination may be made whether an end of life event has occurred or has been detected. If no end of life event, the method may revert to 405 for continued operation of the lamp. In this sense, the loop between 405 and 410 may represent a continuous monitoring-and-feedback loop that facilitates monitoring the lamp for an EOL event without disturbing operation of the lamp.

If an EOL is detected at step 410, then at step 415, a determination may be made regarding whether lamp's current is positive or negative. If the lamp's current is positive, then at step 420, the half bridge block capacitor C2 will be set to a very high DC voltage. In step 425, the high voltage will flow through zener D3. In step 430, the photocoupler U1 will begin to operate such that the photocoupler transistor is turned ON. In step 435, the half bridge power BJT driver will shut down so that the half bridge will stop.

If the lamp's negative current is high at step 415, then at step 440, the half bridge block capacitor C2 will be very negative voltage. In step 445, the negative voltage flow through zener D3. In step 450, the photocoupler U1 will operate such that the photocoupler transistor U1 turns ON. In step 455, the half-bridge power BJT driver will shut down so that the half-bridge stops operating.

Alternative embodiments, examples, and modifications which would still be encompassed by the invention may be made by those skilled in the art, particularly in light of the foregoing teachings. Further, it should be understood that the terminology used to describe the invention is intended to be in the nature of words of description rather than of limitation.

Those skilled in the art will also appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. An end-of-life protection circuit for a non-isolated electronic ballast, comprising:
a driver circuit connected to an output circuit for controlling operation of a load;
a sampling circuit configured to sample direct current (DC) voltage values of a capacitor of a lamp coupled to the ballast to detect the occurrence of an asymmetric event; and
a control circuit for receiving a voltage value in response to the detection of the asymmetric event from the sampling circuit and for outputting to the driver circuit a control signal to control operation of the driver to prevent end of life damage.

2. The circuit of claim 1, wherein the DC voltage value is changed upon detecting the asymmetric event.

3. The circuit of claim 1, wherein driver circuit comprises a half bridge driver circuit including a DC voltage, a half bridge control, a power supply for the half bridge and driver MOSFETs, wherein the half bridge driver is configured to set a frequency output for the output circuit and provide end of life protection for the lamp.

4. The circuit of claim 3, wherein the driver circuit triggers the half bridge driver to change a half bridge control, shut down the half bridge or output a high frequency when the asymmetric event is detected.

5. The circuit of claim 1, wherein the output circuit comprises a limit inductor, an oscillation capacitor and a lamp load.

6. The circuit of claim 1, wherein the sampling circuit comprises a half bridge capacitor, a pair of resistors, and an end of life sensor capacitor.

7. A method for providing end-of-life protection for a non-isolated electronic ballast configure for coupling a lamp thereto, comprising:
sampling direct current (DC) voltage values of a capacitor of the lamp to detect occurrence of an asymmetric event in the ballast;
receiving, as input to a control circuit, a voltage value in response to detecting the asymmetric event; and
outputting, from the control circuit, to a driver circuit, a control signal to control operation of the driver circuit to prevent end of life damage.

8. The method of claim 7, further comprising changing the DC voltage value upon detecting the asymmetric event.

9. The method of claim 7, wherein the driver circuit comprises a half bridge driver circuit including a DC voltage, a half bridge control, a power supply for the half bridge driver and driver MOSFETs, wherein the half bridge driver is configured to set a frequency output for the output circuit and provide the end of life protection for the lamp.

10. The method of claim 9, further comprising triggering the half bridge driver to change a half bridge control, shut down the half bridge or output a high frequency when the asymmetric event is detected.

11. The method of claim 7, wherein outputting, from the control circuit, to a driver circuit further comprises proving an output circuit including a limit inductor, an oscillation capacitor and a lamp load.

12. The method of claim 7, wherein sampling the DC voltage values further comprises providing a sampling circuit including a half bride capacitor, a pair of resistors, and an end of life sensor capacitor.

13. An end-of-life protection circuit for an isolated electronic ballast, comprising:
a driver circuit connected to an output circuit for controlling operation of a load; and
a detect and control circuit for monitoring direct current (DC) voltage values of a capacitor of lamp to detect the occurrence of an asymmetric event and for outputting to the driver circuit a control signal to control the operation of the driver to prevent end of life damage.

14. The circuit of claim 13, wherein the DC voltage value is changed upon detecting the asymmetric event.

15. The circuit of claim 13, wherein driver circuit comprises a half bridge driver circuit including a DC voltage, a pair of electrolytic capacitors, a limit transformer, an oscillation capacitor, a half bridge power bipolar junction transistor (BJT), and a pair of resistors.

16. The circuit of claim 15, wherein the half bridge power BJT shuts down such that the half bridge driver stops operating when the asymmetric event is detected.

17. The circuit of claim 15, wherein the output circuit comprises an oscillation capacitor, an output transformer, and a lamp load.

18. A method for providing end-of-life protection for an isolated electronic ballast including a driver circuit, the electronic ballast being configured for coupling to a lamp, the method comprising:
monitoring direct current (DC) voltage values of a capacitor coupled to the lamp to detect occurrence of an asymmetric event; and
outputting to the driver circuit a control signal to control operation of the driver circuit to prevent end of life damage.

19. The method of claim 18, further comprising changing the DC voltage value upon the detection of the asymmetric event.

20. The method of claim 18, further comprising shutting down the half bridge power BJT such that the half bridge driver stops operating when the asymmetric event is detected.
